(19) United States
(12) Patent Application Publication
(10) Pub. No.: US 2022/0271686 A1
(43) Pub. Date: Aug. 25, 2022

(54) AN ELECTRICAL GENERATOR AND METHOD OF GENERATING AN ELECTRICAL CURRENT

(71) Applicant: PARAGRAF LIMITED, Somersham (GB)

(72) Inventors: Ivor GUINEY, Somersham (GB); Martin TYLER, Somersham (GB); Simon THOMAS, Somersham (GB)

(73) Assignee: PARAGRAF LIMITED, Somersham (GB)

(21) Appl. No.: 17/625,003

(22) PCT Filed: Jul. 7, 2020
(86) PCT No.: PCT/EP2020/069091

§ 371 Date: Jan. 5, 2022

(30) Foreign Application Priority Data
Jul. 16, 2019 (GB) 1910194.8

(51) Int. Cl. H02N 1/04

(52) U.S. Cl. CPC H02N 1/04

(57) ABSTRACT

The present invention provides an electrical generator comprising one or more graphene sheets, each graphene sheet comprising first and second electrical contacts and having a surface extending between the first and second electrical contacts arranged to contact a flow of an ion-containing fluid, wherein each surface is provided with a polymer coating having a thickness of less than 100 nm.

The present invention relates to an electrical generator and a method of generating an electrical current. In particular, the electrical generator comprises one or more graphene sheets where each surface of each sheet is provided with a polymer coating. The electrical generator can be used in a method of generating an electrical current by passing a flow of an ion-containing fluid across the surface, the generator affording an improved output electrical current.

Graphene is a well-known material with a plethora of proposed applications driven by the material's theoretical extraordinary properties. Good examples of such properties and applications are detailed in ‘The Rise of Graphene’ by A. K. Geim and K. S. Novoselev, Nature Materials, Volume 6, 183-191, March 2007 and in the focus issue of Nature Nanotechnology, Volume 9, Issue 10, October 2014.

WO 2017/029470, the content of which is incorporated herein by reference, discloses methods for producing two-dimensional materials. Specifically, WO 2017/029470 discloses a method of producing two-dimensional materials such as graphene, comprising heating a substrate held within a reaction chamber to a temperature that is within a decomposition range of a precursor, and that allows graphene formation from a species released from the decomposed precursor; establishing a steep temperature gradient (preferably >1000° C. per meter) that extends away from the substrate surface towards an inlet for the precursor; and introducing precursor through the relatively cool inlet and across the temperature gradient towards the substrate surface. The method of WO 2017/029470 may be performed using vapour phase epitaxy (VPE) systems and metal-organic chemical vapour deposition (MOCVD) reactors.

The method of WO 2017/029470 provides two-dimensional materials with a number of advantageous characteristics including: very good crystal quality; large material grain size; minimal material defects; large sheet size; and self-supporting. Graphene is a well-known term in the art and refers to an allotrope of carbon comprising a single layer of carbon atoms in a hexagonal lattice. The term graphene used herein encompasses structures comprising multiple graphene layers stacked on top of each other. The term graphene layer is used herein to refer to a graphene monolayer. Said graphene monolayers may be doped or undoped. The graphene sheets and graphene layer structures disclosed herein are distinct from graphite since the layer structures retain graphene-like properties.

Graphene is being investigated for a range of potential applications including use in a range of energy devices including solar cells, supercapacitors and lithium-ion batteries. Of particular interest is graphene based electrical generators which enable the conversion of mechanical energy into electrical energy.

The advantages of such devices capable or harvesting mechanical energy from the environment and converting it into electrical energy includes recollecting otherwise wasted energy and converting it into useful energy. These devices operate on the basis of the “triboelectric effect”. The device generates electric charges which are then separated under mechanical work and the potential difference generated by the separation may drive the flow of electrons. Such devices are also known as triboelectric nanogenerators.

GB 2572330 relates to an array of graphene sheets which generate electricity from a flow of ion-containing fluid.

CN 102307024 discloses a graphene-based fluid power generating device and a wave or fluctuation sensing device.

U.S. Pat. No. 8,519,596 relates to graphene based triboelectric generators and methods of generating electricity. Graphene may be disposed on a polyester layer so as to face the triboelectric layer. The graphene disposed on polyester is contacted with the triboelectric layer and separated (which may be achieved through sliding or pressing and releasing) in order to generate electricity.

CN 108847779 relates to a light-driven triboelectric nanogenerator. A flexible polyimide or polypropylene film, for example, has a reduced graphene oxide layer disposed on the surface thereof. When light is applied, the flexible composite film may bend in shape in order to contact the surface of the graphene with a lower composite film.

These prior art devices rely on the contact of a graphene surface with a triboelectric material. It has also been shown to be possible to convert the mechanical energy of moving ionic liquids to electrical energy using a graphene-liquid interface providing an alternative method for electricity generation.

Mechanism of Electric Power Generation from Ionic Droplet Mention on Polymer Supported Graphene by S. Yang et al. (J. Am. Chem. Soc. 2018, 140, 13746-13752) relates to a polymer supported graphene monolayer device for electric voltage generation. The graphene based electrical generator converts mechanical energy of a flow of ionic droplets over the device surface into electricity. There is disclosed a device comprising a substrate (such as silicon dioxide), a polymer disposed on a surface of the substrate (such as PMMA or PET) and a graphene monolayer disposed on a surface of the polymer and electrodes disposed thereon.

UK patent application number GB1804790.2, the contents of which is incorporated herein by reference in its entirety, discloses devices and methods for generating electricity, in particular, discloses the use of an array comprising a plurality of graphene sheets to generate electricity from a flow of an ion-containing fluid.

However, there remains a need for more efficient nanogenerators capable of providing greater voltage output. It is an object of the present invention to provide improved electrical generators and methods of generating electrical currents, which overcomes, or substantially reduces, the problems associated with the prior art or to at least provide a commercially viable alternative thereto.

The inventors have discovered that an electrical generator as described herein is longer-lasting and provides an improved output of electrical current over a greater length of time without deterioration or degradation of the device and/or the surface of the graphene sheet. In other words, the generator maintains greater stability with regards to electrical output.

Accordingly, in a first aspect there is provided an electrical generator comprising one or more graphene sheets, each graphene sheet comprising first and second electrical contacts and having a surface extending between the first and second electrical contacts arranged to contact a flow of an ion-containing fluid, wherein each surface is provided with a polymer coating having a thickness of less than 100 nm. There is no particular lower limit for the thickness, provided that a conformal film can be formed across the surface. Preferred thicknesses include from 1 to 75 nm, preferably 5 to 50 nm and most preferably from 10 to 20 nm.

The present disclosure will now be described further. In the following passages, different aspects/embodiments of the disclosure are defined in more detail. Each aspect/embodiment so defined may be combined with any other aspect/embodiment or aspects/embodiments unless clearly indicated to the contrary. In particular, any feature indicated as being preferred or advantageous may be combined with any other feature or features indicated as being preferred or advantageous.

The electrical generator comprises one or more graphene sheets. A graphene sheet may be a single graphene monolayer. Preferably, graphene sheets as described herein comprise multiple graphene monolayers in a graphene layer structure. In a preferred embodiment, the electrical generator comprises one or more graphene sheets wherein each graphene sheet has a graphene layer structure comprising from 1 to 50 graphene layers.

The provision of high-quality graphene sheets is key to the application of the invention. In particular, for some applications it is key that the sheets are sufficiently large to provide a low-cost solution. In other applications it is key that the graphene sheets are sufficiently thin that they are optically transparent. In still other applications it is key that the graphene sheets are sufficiently robust, i.e. are substantially devoid of weaknesses arising from structural imperfections.

The graphene sheets as described herein may be doped or undoped. Preferably, the graphene sheets are doped. Graphene sheets may be doped with an n-type dopant or a p-type dopant. n-type dopants are electron donating elements whereas p-type dopants are electron acceptor elements. Common graphene dopants include magnesium (Mg), zinc (Zn), boron (B), silicon (Si), nitrogen (N), phosphorus (P), arsenic (As), oxygen (O), fluorine (F), chlorine (CI), bromine (Br) and combinations thereof. Preferably, the graphene sheets are n-type doped and/or p-type doped. Even more preferably, the graphene sheets are doped with one or more of Mg, N, P and Br.

The electrical generator may comprise more than one graphene sheet. Preferably, the electrical generator comprises a plurality of graphene sheets. Said graphene sheets are then arranged in an array wherein each graphene sheet is in electrical contact with at least a further graphene sheet. An array is intended to refer to a structure wherein said graphene sheets are arranged with an edge proximal to the edge of another, as opposed to the stacking of said sheets so as to have the surfaces of the graphene sheets proximal to one another.

As will be appreciated, the number of connections will depend on whether the sheets are wired in parallel or in series and where each sheet is located in the array. A sheet in the middle of a chain will have at least two connections to adjacent graphene sheet, whereas a sheet at the end of a chain will may only have a single connection to a further sheet and a contact for connection to an external circuit.

Preferably, the graphene sheets are in electrical contact in series or in parallel. This may affect the current or voltage produced. That is, altering the configuration of the electrical connections between the sheets in a given array may allow tuning of the voltage and/or current produced by the array.

Preferably, in order to minimise the amount of space within the array that does not comprise an electrical generator, the plurality of graphene sheets are arranged with a tessellating shape. Preferably, the tessellating shape is one of hexagonal, square or rectangular. This maximises the area of the array that is capable of producing an electrical current and therefore increases the current output for an electrical generator of a given size relative to one that comprises an array wherein the graphene sheets are not tessellating.

The array may be planar or approximately planar when used in a planar device such as a solar panel or a window. Alternatively, the array may be curved when used in a curved device such as on the surface of a pipe.

Graphene sheets may be prepared by methods such as liquid exfoliation, solid exfoliation, oxidation-exfoliation-reduction and intercalation-exfoliation. These methods typically employ bulk graphite as a raw starting material relying on exfoliation (in a top-down approach) as the method by which individual graphene sheets are separated from the bulk. If a free graphene layer is provided then this can be adhered to a substrate. Graphene may be prepared using chemical vapour deposition (CVD) techniques. Preferably, a graphene layer structure is prepared by vapour phase epitaxy (VPE) and/or by metal-organic chemical vapour deposition (MOCVD). Preferably, graphene is prepared by the method disclosed in WO 2017/029470, i.e. an MOCVD-type technique.

MOCVD is a term used to describe a system used for a particular method for the deposition of layers on a substrate. While the acronym stands for metal-organic chemical vapour deposition, MOCVD is a term in the art and would be understood to relate to the general process and the apparatus used therefor and would not necessarily be considered to be restricted to the use of metal-organic reactants or to the production of metal-organic materials. Instead, the use of this term indicates to the person skilled in the art a general set of process and apparatus features. MOCVD is further distinct from CVD techniques by virtue of the system complexity and accuracy. While CVD techniques allow reactions to be performed with straight-forward stoichiometry and structures, MOCVD allows the production of difficult stoichiometries and structures. An MOCVD system is distinct from a CVD system by virtue of at least the gas distribution systems, heating and temperature control systems and chemical control systems. An MOCVD system typically costs at least 10 times as much as a typical CVD system. CVD techniques cannot be used to achieve high quality graphene layer structures.

MOCVD can also be readily distinguished from atomic layer deposition (ALD) techniques. ALD relies on step-wise reactions of reagents with intervening flushing steps used to remove undesirable by products and/or excess reagents. It does not rely on decomposition or dissociation of the reagent in the gaseous phase. It is particularly unsuitable for the use of reagents with low vapour pressures such as silanes, which would take undue time to remove from the reaction chamber. MOCVD growth of graphene is discussed in WO 2017/029470.

Graphene prepared by MOCVD-type methods as described herein may have improved properties when compared to graphene prepared by other known methods (such as exfoliation based methods). Graphene may be prepared having a grain size greater than 20 μm. Graphene may be prepared covering a 6 inch (15 cm) substrate having undetectable discontinuity. The electrical generator preferably comprises one or more graphene sheets which are obtainable by the deposition of graphene on a surface of a substrate by MOCVD or CVD, even more preferably by MOCVD.

The surface of the substrate may comprise a semiconductor material, preferably, a III-V semiconductor material. III-V semiconductor substrates may include binary III-V semiconductor substrates such as GaN, AIN and InAs and also tertiary, quaternary and higher order III-V semiconductor substrates such as InGaN, InGaAs, AIGaN, InGaAsP. Preferably, the substrate comprises a support selected from the group consisting of silicon (Si), silicon dioxide (SiO₂), silicon carbide (SiC), silicon nitride (SiN), sapphire (Al₂O₃) or a III-V semiconductor.

Each graphene sheet comprises at least a first and second electrical contact. Each electrical contact may be prepared by any method known in the art. Typically, the electrical contact is a conductive metal contact formed from the deposition of a metal, which may include copper, gold, nickel, palladium, platinum, silver, titanium or combinations thereof, on a graphene sheet coated with a patterned photoresist polymer layer. This is then followed by the removal of the excess metal deposited on the surface of the photoresist using a “lift-off” method.

It will be appreciated that specific position and arrangement of the contacts may affect the flow of fluid over the graphene surface. Accordingly, the preferred arrangement of the contacts may vary between specific devices into which the array is incorporated.

In particular, contacts which represent an obstruction to the fluid flow may lead to non-laminar flow and reduce the electric power generated. In a preferred embodiment the contacts are arranged to avoid such non-laminar flow. The arrangement of the contacts would be understood to mean both the shape of the contacts as well as the position of the contacts on the sheet.

Each graphene sheet preferably comprises only a first and second electrode and no further electrodes. The graphene sheet comprising at least first and second electrical contacts has a surface extending between the two contacts. In a preferred embodiment, the first and second electrical contacts are located at distal portions of each graphene sheet. It will be apparent that graphene sheets may not have an idealised shape (such as a circle or square) and therefore, one of ordinary skill in the art will readily appreciate the meaning of first and second electrode located at distal portions of each graphene sheet. Distal portions of each graphene sheet is intended to mean that the first and second electrical contacts are arranged to as to have substantially maximal separation between the two. In other words, for an approximately circular graphene sheet, electrical contacts may be positioned approximately on the circumference separated by a distance approximately equal to the diameter. For an approximately rectangular graphene sheet, electrical contacts may be arranged approximately in opposite corners across the diagonal. As a result, a greater surface extending between the first and second electrical contacts may be achieved.

The surface of the graphene sheet extending between the first and second electrical contacts is arranged to contact a flow of an ion-containing fluid. In other words, the surface of the graphene sheet is positioned so that and ion-containing fluid that is in motion may be contacted with the graphene sheet. The graphene-based electrical generator is capable of converting the mechanical energy of the flow of the ion-containing fluid over the surface of the graphene sheet into electrical energy.

The ion-containing fluid may be any fluid comprising ionic species. That is, the term is not intended to be limited to molten salts, but to encompass solutions containing charged species, particularly, sea water or rainwater as well as waste fluids such as industrial or agricultural drainage, run off from chemical plants or power plants. Preferably, the ion-containing fluid is an ion-containing liquid. Preferably, the ion-containing liquid may be and ion-containing alcohol, ester, water or combinations thereof. Most preferably, the ion-containing liquid is an ion-containing water.

The ionic species may be any species that forms at least a portion of separated ions upon dissolution in the fluid. Preferably, ion-containing fluid has a pH that is greater than 1 and/or less than 14, more preferably, greater than 4 and less than 10. Preferably, the ionic species are inorganic salts, preferably inorganic salts that substantially fully dissociate upon dissolution in the fluid. In a preferred embodiment, the ion-containing fluid has an ionic strength of greater than about 0.005 M, preferably greater than about 0.001 M, more preferably greater than about 0.01 M, even more preferably greater than about 0.1 M and most preferably greater than about 0.5 M, such as up to 8 M.

Preferably, the ion-containing fluid is an aqueous solution of cations of lithium, sodium, potassium, magnesium, calcium or ammonium and anions of fluoride, chloride, bromide, iodide, sulfate, sulfite, nitrate, nitrite, phosphate, hydrogen phosphate, dihydrogen phosphate, acetate, carbonate or bicarbonate; or combinations thereof. Preferably, the ion-containing fluid is an aqueous solution of an alkali metal halide salt, such as sodium chloride.

While any fluid containing charged species may be used, it will be appreciated that the ion concentration will affect the power generated by the device. However, the choice of ion-containing fluid is not otherwise limited.

The inventors have realised that graphene-based nanogenerators capable of harvesting mechanical energy from ionic liquids are not reliable and/or long-lasting. Without wishing to be bound by theory, it is believed that contact between the droplet of ionic liquid and the surface of the graphene sheets alters the surface leading to easier wetting of the film. As a result, the electrical output begins to deteriorate over time, the inventors having discovered that the electrical output may drop to below an unrecordable value in approximately 30 minutes.

Advantageously, the inventors have found that by providing a thin polymer film coating on the graphene surface it is possible to physically isolate it from the environment whilst still allowing the ion-containing fluid to electrically affect the graphene surface. As a consequence, the electrical output can be maintained well in excess of a 30 minute period without significantly reducing the peak performance relative to uncoated graphene. In particular, the inventors have demonstrated performance with no degradation of voltage beyond 180 minutes due to the presence of the polymer layer described herein. Accordingly, each surface of the graphene sheet is provided with a polymer coating having a thickness of less than 100 nm. Preferably, the polymer coating has a thickness of from 1 nm to 7 nm, preferably about 5 nm. It has been found that such a polymer thickness provides graphene with adequate protection from the environment without detrimentally affecting the electricity generating properties.

In a preferred embodiment, the polymer coating comprises poly(methyl methacrylate) (PMMA), polyethylene terephthalate (PET), polyphenylene ether ether sulfone (PPEES), poly(2,6-dimethyl-1,4-phenylene oxide), polyurethane, polyethylene, polyvinylidene fluoride (PVDF) and/or poly(tetrafluoroethylene) (PTFE). PMMA, PPEES and poly(2,6-dimethyl-1,4-phenylene oxide) are especially preferred.

In some embodiments of the present invention, it is preferable for the polymer coating to act as a passivation layer and is therefore electrically insulative. In other embodiments, it is preferable that the polymer coating is doped. In other words, the polymer coating may comprise an organic chemical dopant that may oxidise or reduce the polymer by the removal or addition of electrons to the polymer. The polymer may be n-type doped meaning a reducing dopant is added which introduces electrons into the polymer coating. Preferably, polymer coating is p-type doped meaning an oxidising dopant is added which introduces electron holes into the polymer coating. The inventors have found that doping the polymer film with a dopant results in an increase in the energy production of the electrical generator by up to twice that of an electrical generator comprises an undoped polymer coating. Without wishing to be bound by theory, the introduction of a dopant into the polymer coating results in an increased in the charge carrier density of the polymer coating thereby allowing a greater electrical influence of the flow of ion-containing fluid on the graphene sheet.

Examples of p-type dopants include 7,7,8,8-tetracyanoquinodimethane (TCNQ), 2,3,5,6-tetrafluoro-7,7,8,8-tetracyanoquinodimethane (F₄TCNQ), phenyl-C61-butyric acid methyl ester (PCBM), bis(ethylenedithio)tetrathiafulvalene (BEDT-TTF) and NDI(CN)₄ (tetracyano-napthalenediimide). In a most preferred embodiment, the polymer coating is doped with F₄TCNQ.

The dopant may be added in an amount of greater than about 0.1 wt % based on the weight of the polymer coating, preferably greater than about 1 w t%, more preferably greater than about 10 wt % and most preferably greater than about 20 wt %. The dopant may be added in an amount less than 80 wt % based on the weight of the polymer coating, preferably less than 60 wt %, more preferably less than 50 wt % and most preferably less than 40 wt %.

According to a second aspect, there is provided a method of generating an electrical current, the method comprising passing a flow of an ion-containing fluid across the surface of at least one of the one or more graphene sheets of the electrical generator as described herein.

Whilst the electrical generator as described herein provides an improvement over the prior art, the electrical output of the electrical generator may still decline somewhat over time. Advantageously, the inventors have realised that the electrical generator may be regenerated by washing and/or drying the polymer coating. Accordingly, in a preferred embodiment, the method of generating an electrical current further comprises intermittently regenerating the electrical generator by washing and/or drying the polymer coating of at least one of the one or more graphene sheets.

The device for generating electrical energy from a flow of an ion-containing fluid can be arranged to generate electricity from a flow of rain water as the ion-containing fluid.

Examples of this type of device include a surface of a roof tile, a wall panel, a car body panel, a drainage duct. In several devices the one or more arrays are optically transparent. Examples of this type of device include where the one or more arrays form a surface of a window or a solar panel.

In several devices the one or more arrays are arranged to generate electricity from a flow of sea water as the ion-containing fluid. Examples of this type of device include where the arrays form a surface of a hull of a boat, or a tidal power generator (such as a duct or panel within a tidal power generator).

In several devices the one or more arrays are arranged to generate electricity from a flow of waste fluid, preferably wherein the arrays form a surface of a sanitary-ware product, or a duct for sewage or farm drainage. Other suitable waste drainage ducts include the run-off from industrial plants (such as chemical plants, nuclear, pharmaceutical, dairy, etc.).

### FIGURES

The present invention will now be described further with reference to the following non-limiting Figures, in which:

FIG. 1 shows a cross section of a prior art electrical generator.

FIG. 2 shows an exemplary electrical generator according to the present disclosure.

FIG. 3 shows a plot illustrating the voltage generated over time with regular droplets of ionic fluid striking a graphene sheet coated with PMMA:F₄TCNQ, after 15 minutes.

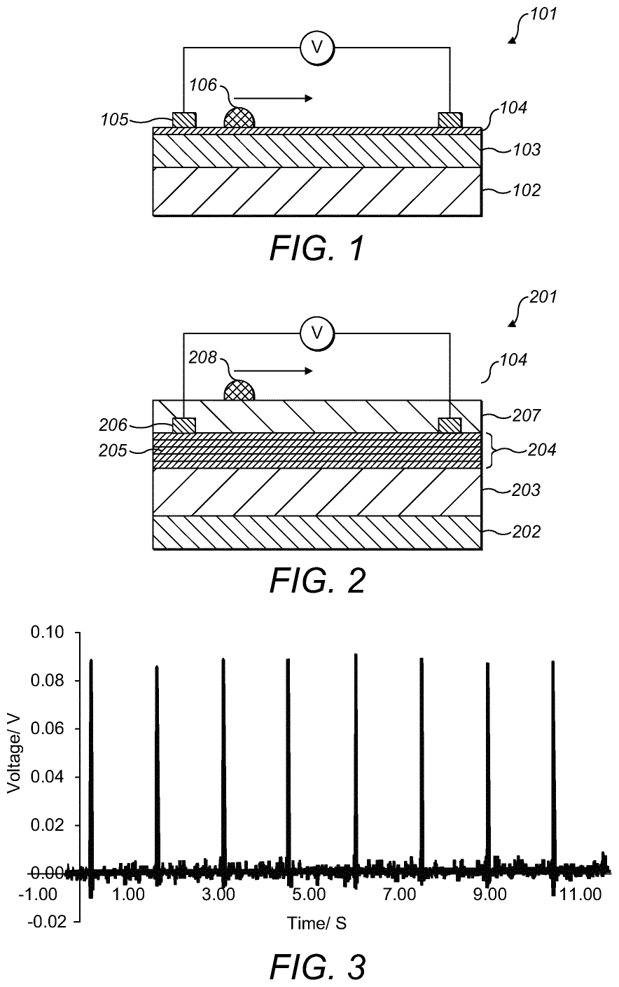

FIG. 1 illustrates an example of a prior art electrical generator (101). The generator (101) comprises a silicon dioxide (SiO₂) substrate (102) having a polymer coating (103), such as PMMA or PET, disposed thereon. A single graphene layer (104) is disposed on the surface of the polymer coating. The single graphene layer comprises electrical contacts (105) so as to have a surface of the graphene layer (104) extending between the electrical contacts (105). The surface of the graphene layer is arranged to contact a flow of a sodium chloride

(NaCl) aqueous solution (106). The electrical generator may be connected by the electrical contacts to an electrical circuit. The flow of the sodium chloride solution (106) across the surface of the graphene layer (104) extending between the electrical contacts (105) may generate an electrical current/potential difference.

The prior art electrical generator (101) is obtained by deposition of graphene on a copper foil followed by coating the graphene layer (104) with a polymer coating (103) such as PMMA or PET and attaching a fused silicon dioxide substrate (102) to the polymer coating (103). The copper foil is then etched away to leave the exposed graphene layer (104) upon which electrical contacts may be provided.

FIG. 2 illustrates an exemplary electrical generator (201) according to the present invention. The generator (201) comprises a support (202) such as a silicon support, and a substrate (203) disposed thereon, such as a gallium nitride (GaN) substrate.

The generator (201) comprises a graphene sheet (204) which has a graphene layer structure comprising five individual graphene layers (205) on the surface of the substrate, obtained by deposition of graphene by MOCVD.

The graphene sheet (204) comprises first and second electrical contacts (206), the graphene sheet (204) has a surface extending between the first and second electrical contacts (206). The surface of the graphene sheet is provided with a polymer coating (207). The polymer coating is preferably provided by spin coating. The surface extending between the electrical contacts is arranged to contact the flow of an ion-containing fluid (208) such as an aqueous sodium chloride solution. The generator (201) is capable of generating an electrical current upon contact of the surface with a flow of an ion-containing fluid when connected to an electrical circuit. The generator (201) may maintain a reasonable electrical output in excess of 30 minutes as a result of the polymer coating (207) physically isolating the graphene sheet (204) from the flow of the ion-containing fluid (208).

### EXAMPLES

A graphene sheet was taken directly from a desiccator where it had been stored since growth. This was cut into three 15 mm×30mm chips which were then painted along the short edge with Ag paint. Onto one of these chips (labelled B) was spin coated PMMA in anisole (0.5% sol) at 10000 rpm for 60 seconds followed by annealing on the hotplate at 125° C. (display 160° C.) for 60 minutes. Onto another chip, the same spin conditions were used but with a 10 mg/mL F₄TCNQ:PMMA 0.52 wt % hybrid solution (labelled C).

The contact resistance between two electrodes when mounted on a PCB for the bare sample (labelled A) was 21.62 kOhm. This sample was then tested under droplet flow (0.6 M NaCl sol, ˜1 drop per second, 3.3 kΩ resistor) over 30 minutes which led to complete degradation of the sample. The same treatment was repeated for samples B and C over 60 minutes which had contact resistances of 5.04 kOhm and 3.80 kOhm for B and C respectively:

| | Contact | | | | | | | |
|---|---|---|---|---|---|---|---|---|
| | Resistance | T = 0 min | T = 5 min | T = 15 min | T = 30 min | | T = 60 min | |
| Sample | (kΩ) | peak V | peak V | peak V | peak V | | peak V | |
| A | 21.62 | 0.051 V | 0.009 V | 0.008 V | 0 | V | 0 | V |
| B | 5.04 | 0.127 V | 0.062 V | 0.032 V | 0.024 | V | 0.020 | V |
| C | 3.80 | 0.129 V | 0.089 V | 0.090 V | 0.042 | V | 0.031 | V |

| | Contact | | | | | |
|---|---|---|---|---|---|---|
| | Resistance | T = 0 min | T = 5 min | T = 15 min | T = 30 min | T = 60 min |
| Sample | (kΩ) | peak P | peak P | peak P | peak P | peak P |
| A | 21.62 | 7.9e−7 W | 2.5e−8 W | 1.9e−8 W | — | — |
| B | 5.04 | 4.9e−7 W | 1.2e−6 W | 3.1e−7 W | 1.7e−7W | 1.2e−7 W |
| C | 3.80 | 5.0e−7 W | 2.4e−6 W | 2.5e−6 W | 5.3e−7W | 2.9e−7 W |

As can be seen, for inventive examples B and C, the voltage and power produced remain at acceptable levels, whereas for the uncoated sample A, these drop over time such that after 30 minutes, no power is being generated. As well as being long-lasting, inventive examples B and C were regenerated with washing and drying and returned to their high initial performance.

All percentages herein are by weight unless otherwise stated.

As used herein, the singular form of “a”, “an” and “the” include plural references unless the context clearly dictates otherwise.

The foregoing detailed description has been provided by way of explanation and illustration, and is not intended to limit the scope of the appended claims. Many variations in the presently preferred embodiments illustrated herein will be apparent to one of ordinary skill in the art, and remain within the scope of the appended claims and their equivalents.

1. An electrical generator comprising one or more graphene sheets, each graphene sheet comprising first and second electrical contacts and having a surface extending between the first and second electrical contacts arranged to contact a flow of an ion-containing fluid, wherein each surface is provided with a polymer coating having a thickness of less than 100 nm.

2. The electrical generator according to claim 1 comprising a plurality of said graphene sheets arranged in an array wherein each graphene sheet is in electrical contact with at least a further graphene sheet.

3. The electrical generator according to claim 2, wherein the plurality of graphene sheets have a tessellating shape, preferably hexagonal, square or rectangular.

4. The electrical generator according to any claim 1, wherein the first and second electrical contacts are located at distal portions of each graphene sheet.

5. The electrical generator according to claim 1, wherein the one or more graphene sheets are obtainable by the deposition of graphene on a surface of a substrate by MOCVD or CVD.

6. The electrical generator according to claim 5, wherein the surface of the substrate comprises a III-V semiconductor material.

7. The electrical generator according to claim 5, wherein the substrate comprises a support selected from the group consisting of silicon, silicon carbide, silicon dioxide, silicon nitride or sapphire.

8. The electrical generator according to claim 1, wherein each graphene sheet has a graphene layer structure comprising from 1 to 50 graphene layers.

9. The electrical generator according to claim 1, wherein the graphene sheets are doped, preferably wherein the graphene sheets are n-type doped and/or p-type doped, preferably with one or more of Br, N, Mg and P.

10. The electrical generator according to claim 1, wherein the polymer coating comprises PMMA.

11. The electrical generator according to claim 1, wherein the polymer coating has a thickness of from 1 nm to 7 nm.

12. The electrical generator according to claim 1, wherein the polymer coating is doped, preferably wherein the polymer coating is p-type doped, preferably wherein the polymer coating is doped with 2,3,5,6-tetrafluoro-7,7,8,8-tetracyanoquinodimethane.

13. A method of generating an electrical current, the method comprising passing a flow of an ion-containing fluid across the surface of at least one of the one or more graphene sheets of the electrical generator according to claim 1.

14. The method according to claim 13, the method further comprising intermittently regenerating the electrical generator by washing and/or drying the polymer coating of at least one of the one or more graphene sheets.

15. The electrical generator according to claim 6, wherein the substrate comprises a support selected from the group consisting of silicon, silicon carbide, silicon dioxide, silicon nitride or sapphire.
